(19) United States
(12) Patent Application Publication
(10) Pub. No.: US 2021/0378321 A1
(43) Pub. Date: Dec. 9, 2021

(54) POWER CONDITIONER FOR HEATED WEARABLE GEAR

(71) Applicant: MILWAUKEE ELECTRIC TOOL CORPORATION, Brookfield, WI (US)

(72) Inventor: Zachary G. Stanke, Wausau, WI (US)

(21) Appl. No.: 17/337,929

(22) Filed: Jun. 3, 2021

Related U.S. Application Data
(60) Provisional application No. 63/034,719, filed on Jun. 4, 2020.

(51) Int. Cl. A41D 13/005; H05B 1/02

(52) U.S. Cl. CPC A41D 13/0051; A41D 2400/10; H05B 1/0272

(57) ABSTRACT

An article of clothing including a garment body and a heater coupled to the garment body. The article of clothing also includes a battery holder separate from the garment body and configured to receive a rechargeable power tool battery pack. The article of clothing also includes a controller selectively providing power from the rechargeable power tool battery pack to the heater, and a control input coupled to the garment body for selecting a mode of the controller. A power conditioner is coupled between the battery pack and the controller and is configured to regulate an output voltage of the battery pack to maintain a constant voltage regardless of the state of charge of the battery.

### RELATED APPLICATIONS

This application claims the benefit of U.S. Provisional Patent Application No. 63/034,719, filed Jun. 4, 2020, the entire content of which is hereby incorporated by reference.

### SUMMARY

Embodiments described herein provide for improved operation of heating devices in wearable gear, such as jackets, gloves, sweaters, hats, etc. Currently, heated gear products operate directly from battery voltage, as the heated gear is often a resistive load. As the battery voltage declines with use, the heated gear becomes less and less effective (i.e. provides less heat to the wearer). Embodiments described herein provide for heated gear systems and methods that can maintain an input (e.g., input power) to a resistive load of the heated gear throughout the battery discharge cycle.

In one embodiment, an article of clothing includes a garment body and a heater coupled to the garment body. The articles of clothing also include a battery or battery pack holder configured to receive a rechargeable battery pack. The articles of clothing also include a controller selectively providing power from the rechargeable battery pack to the heater, and a control input coupled to the garment body for selecting a mode of the controller. A power conditioner is coupled between the battery pack and the controller and is configured to regulate an output voltage of the battery pack to maintain a constant voltage regardless of the state of charge of the battery pack.

In another embodiment, an article of clothing includes a garment body, a heater coupled to the garment body, a battery holder configured to receive a rechargeable battery pack, and a controller. The controller selectively provides power from the rechargeable battery pack to the heater. The article of clothing further includes a power conditioner coupled between the battery pack and the controller. The power conditioner is configured to regulate an output voltage of the rechargeable battery pack to maintain a constant voltage provided to the heater regardless of the state of charge of the rechargeable battery pack. The rechargeable battery pack has a nominal operating voltage range between 10.8 VDC to 14.4 VDC.

In one embodiment, an article of clothing includes a garment body, a heater coupled to the garment body, and a battery holder configured to receive a rechargeable battery pack. The article of clothing also includes a controller selectively providing power from the rechargeable battery pack to the heater, and a power conditioner coupled between the battery pack and the controller. The power conditioner is configured to operate as a step-up/step-down voltage regulator and to regulate an output voltage of the rechargeable battery pack to maintain a constant 12 VDC voltage output to the heater regardless of the state of charge of the rechargeable battery pack. The rechargeable battery pack has a nominal operating voltage range between 2.5 VDC and 18 VDC.

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Other aspects of the embodiments will become apparent by consideration of the detailed description and accompanying drawings.

### BRIEF DESCRIPTION OF THE DRAWINGS

FIG. 1 is a front view of wearable gear according to one embodiment of the invention.

FIG. 2 is a rear view of the wearable gear of FIG. 1.

FIG. 3 is a detailed view of a rear component of the wearable gear of FIG. 2, and taken along line 3-3 of FIG. 2

FIG. 4 is an electrical block diagram for the wearable gear of FIG. 1.

### DETAILED DESCRIPTION

The below embodiments are related to wearable clothing or other gear having a heating mechanism and a removable power supply, such as a rechargeable battery. While the below embodiments are generally related to a heated jacket, it is contemplated that the herein described concepts are applicable to other heated gear items, such as gloves, socks, shoes, boots, hats, inner wear, outer wear, under wear, and the like. Further, the concepts described herein are also applicable to other heated devices with removable power sources, such as seat covers, blankets, etc.

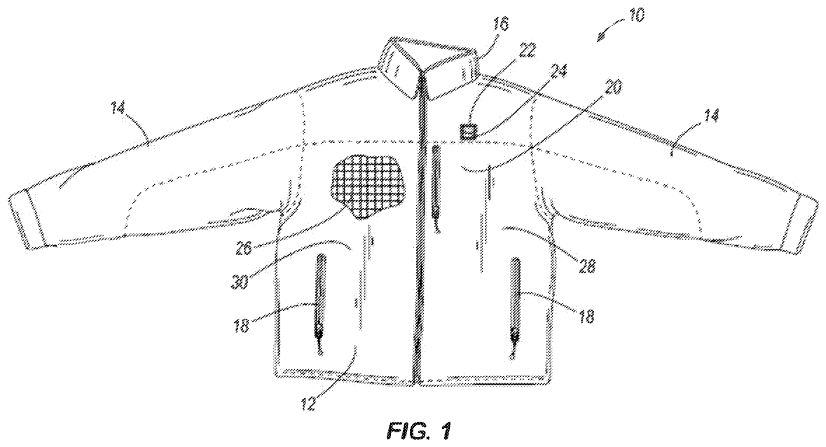

FIG. 1 illustrates a heated jacket 10 according to one embodiment. The heated jacket 10 may be constructed in various sizes to fit a variety of users. The heated jacket 10 includes typical jacket features such as a torso body 12, arms 14, a collar 16, and front pockets 18. A front surface 20 of the heated jacket 10 includes a control input. In the illustrated embodiment, the control input is a button 22 that may be actuated by a user. As explained in greater detail below, the button 22 includes a display portion 24 to indicate a status of the heated jacket 10.

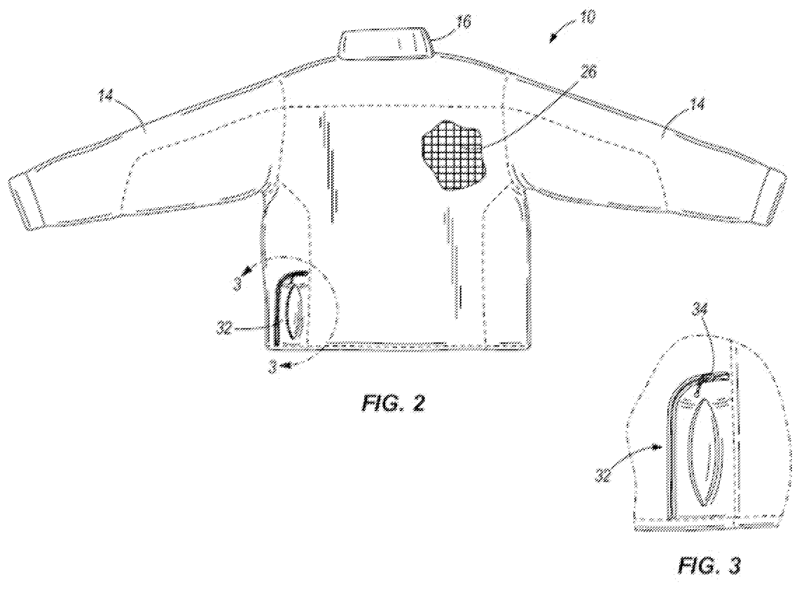

As illustrated in cutaway portions of FIGS. 1 and 2, the heated jacket 10 includes a heater array 26. The heater array 26 is disposed in both a left portion 28 and a right portion 30 of the torso body 12. In some embodiments, the heater array 26 may extend into the arms 14 and/or collar 16. The heater array 26 may be configured to generate heat based on a received DC voltage. For example, the heater array 26 may be a resistive heater array. However, other heater array types are also contemplated. In other embodiments, the heated jacket 10 may include a first heater array and second heater array arranged as an upper module and a lower module, respectively. In the illustrated embodiment, the heater array 26 is controlled via the button 22 shown in FIG. 1. In other embodiments, multiple heater arrays may be controlled individually via a single control input or multiple control inputs. The heater array 26 may include resistive heating coils formed of carbon fibers, high density carbon fibers, or other heating devices. The heated jacket 10 is capable of maintaining a temperature of up to 110 degrees Fahrenheit, although in other embodiments, lower or greater temperatures are possible depending upon the heat source.

As illustrated in FIG. 2, the heated jacket 10 includes a compartment 32 located on a lower portion of the back torso body. The compartment 32 houses an electrical component, such as a battery pack 38 and battery holder. In one embodiment, the battery pack 38 is a rechargeable power tool battery pack, such as an M12 battery or USB battery from Milwaukee Tool.® However, other rechargeable power tool battery packs are also contemplated. In some embodiments, the battery pack 38 is a removable battery pack configured to be removably coupled to the battery holder. However, in other embodiments, the battery pack 38 may be configured to be non-removably coupled to the battery holder. As illustrated in FIG. 3, the compartment 32 includes a zipper 34, providing selective access by a user to the compartment 32 in order to access the battery pack 38 and other electrical components.

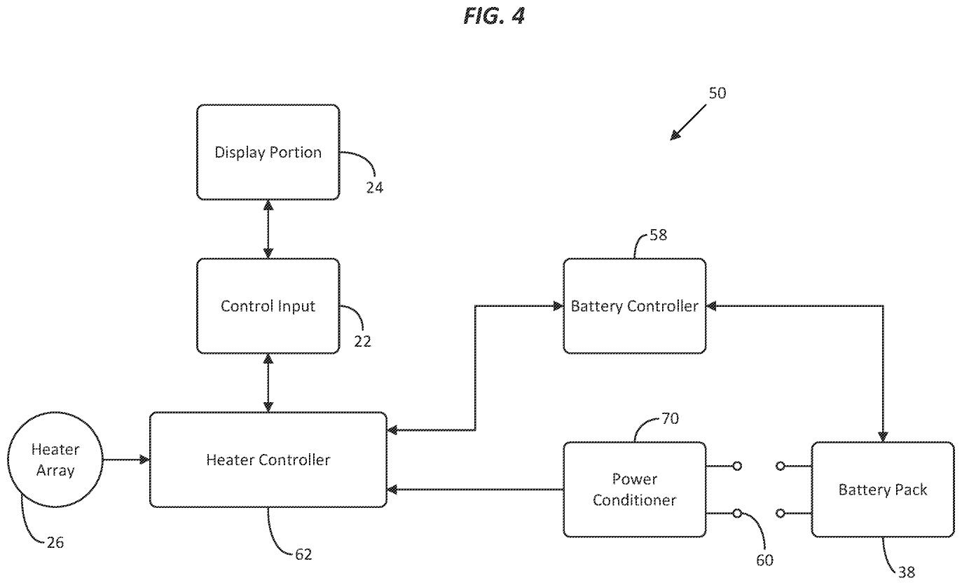

The heated jacket 10 includes a control circuit 50 for the heater array 26 and battery pack 38. FIG. 4 is a block diagram of the heated jacket 10. A battery controller 58 receives electricity from a battery pack 38 via battery terminals 60 (disposed within the battery holder). The battery controller 58 may be configured to monitor a state of charge of the battery pack 38 and, if necessary, shutdown the heater array 26.

In some embodiments, the battery pack 38 includes a total of six battery cells in a parallel arrangement of two sets of three series-connected cells. The series-parallel combination of battery cells creates a battery pack having a nominal voltage of approximately 12 VDC and a capacity rating of approximately 2.8 Ah. In other embodiments, the battery cells may have different nominal voltages, such as, for example, 3.6 VDC, 3.8 VDC, 4.2 VDC, etc., and/or may have different capacity ratings, such as, for example, 1.2 Ah, 1.3 Ah, 2.0 Ah, 2.4 Ah, 2.6 Ah, 3.0 Ah, etc. In other embodiments, the battery pack 38 can have a different nominal voltage, such as for example, 10.8 VDC, 14.4 VDC, etc. In other examples, the battery packs may have more or fewer cells, and may therefore have different nominal voltages, such as 2.5 VDC, 6 VDC, 18V, 24V, 2.5V to 24V, etc. In some embodiments, the battery cells within the battery pack 38 are lithium-ion battery cells, having a chemistry of, for example, lithium-cobalt (Li—Co), lithium-manganese (Li—Mn), or Li—Mn spinel. In other embodiments, the battery cells may have other suitable lithium or lithium-based chemistries.

A heater controller 62 receives inputs from the button 22 and selectively powers the heater array 26 depending upon the selected thermal output. The display portion 24 is selectively illuminated based upon the selected thermal output setting. The heater controller 62 may be configured to monitor a plurality of conditions of the heated jacket 10 including, but not limited to, an amount of current drawn by the heater array 26, the temperature of the heater array 26, etc. The controllers 58, 62 are, for examples, microprocessors, microcontrollers, or the like, and are configured to communicate with one another. In some embodiments, the controllers 58, 62 are combined into a single controller. In the illustrated embodiments, the battery controller 58 provides information to the heater controller 62 related to, for example, a battery pack temperature or battery pack voltage level. The heater controller 62 and the battery controller 58 also include low voltage monitors and state-of-charge monitors. The monitors are used to determine whether the battery pack 38 is experiencing a low voltage condition or is in a state-of-charge that makes the battery pack 38 susceptible to being damaged. If such a low voltage condition or low state-of-charge exists, the heater array 26 is shut down or the battery pack 38 is otherwise prevented from further discharging current to prevent the battery pack 38 from becoming further depleted.

As shown in FIG. 4, the control circuit 50 further includes a power conditioner 70. The power conditioner 70 is configured to provide a constant or near constant voltage from the battery pack 38 to the heater controller 62, and other components within the control circuit 50. Power conditioning addresses efficiency issues with using batteries or battery packs, such as battery pack 38, which can result from a lower voltage being provided to the heater array 26 as the batteries or battery packs begin to discharge. For example, when the heater array 26 is powered directly from the battery pack 38, the power output of the heater array 26 can be expressed as

$$P = \frac{{V}^{2}}{R} .$$

In an example battery pack, the output voltage of a fully charged battery pack cell is 4.2V, and the output voltage of a fully discharged battery pack cell is 3.0V (low-voltage discharge threshold). The relative output power drop can be expressed as shown below in FIG. 4.

$$Relative Power Drop = \frac{{V}_{End of Discharge}^{2}}{{V}_{Start of Discharge}^{2}} = \frac{{3.0}^{2}}{{4.2}^{2}} = 0.51 \qquad Equation 1$$

Therefore, as shown above, for the above example battery pack, the power output of the example battery pack at the end of the discharge is 51% of the maximum output power when fully charged. This can result in the user not receiving as much heat as desired as the battery pack 38 discharges due to the reduction in output power. Accordingly, by conditioning the output power of the battery pack 38 using the power conditioner 70, a constant output can be provided to the heater array 26 throughout the discharge cycle of the battery pack 38.

In some embodiments, the power conditioner 70 is a step-up/step-down regulator. A step-up/step-down regulator may be used where the nominal battery pack voltage is the same as the nominal operating voltage of the heater array 26. For example, the battery pack 38 may be a 12V battery pack, and the heater array 26 may be a 12 VDC heater array. As described above, a battery pack 38 having a 12 VDC nominal voltage may have a voltage output range from 14.4 VDC when fully charged to 10.8 VDC when fully discharged. The step-up/step-down regulator may be configured to maintain a 12 VDC output to the heater array 26 regardless of the voltage of the battery pack 38. Thus, the step-up/step-down converter may reduce the voltage from the battery pack 38 prior to the voltage being provided to the heater array 26 (e.g. converting 14.4 VDC to 12 VDC). Similarly, the step-up/step-down converter may increase the voltage from the battery pack 38 prior to the voltage being provided to the heater array 26 (e.g. converting 11 VDC to 12 VDC). Thus, as the output voltage of the battery pack varies, the step-up/step-down regulator regulates the voltage to maintain the optimal voltage for operating the heater array 26. In some embodiments, the step-up/step-down converter is configured as a Buck-Boost converter. However, other step-up/step-down regulators, such as a SEPIC, Split-pi, or Cuk type regulator can also be used.

In other embodiments, the power conditioner 70 is a step-up only regulator. A step-up regulator may be used as the power conditioner 70 where the nominal battery pack voltage is generally less than the nominal operating voltage of the heater array 26. For example, the battery pack 38 may be a 1 cell battery or battery pack with a nominal voltage of 2.5 VDC, and the heater array 26 may be a 12 VDC heater array. Accordingly, the step-up regulator may be configured to increase, or boost, the output of the 2.5 VDC battery pack to 12 VDC, which is then provided to the heater array 26. In some embodiments, the step-up regulator is configured as a Boost converter.

In other embodiments, the power conditioner 70 is a step-down only regulator. A step-down regulator may be used as the power conditioner 70 where the nominal battery pack voltage is greater than the nominal operating voltage of the heater array 26. For example, the battery pack 38 may have a nominal operating voltage of 18 VDC, and the heater array 26 may be a 12 VDC heater array. Accordingly, the step-down regulator may be configured to reduce the output of the 18 VDC battery output to 12 VDC, which is then provided to the heater array 26. In some embodiments, the step-down regulator is configured as a Buck converter.

The above examples provide only a subset of possible battery pack and heater array voltage combinations. It is contemplated that other battery voltages heater array voltage may be used. The power conditioner 70 allows for multiple combinations of batteries and/or heater arrays to be used to provide heat to a user, while maintaining efficiency throughout the discharge cycle of the battery pack 38.

Various features and advantages are set forth in the following claims.

What is claimed is:

1. An article of clothing comprising:
a garment body;
a heater coupled to the garment body;
a battery holder configured to receive a rechargeable battery pack;
a controller selectively providing power from the rechargeable battery pack to the heater;
a control input coupled to the garment body, the control input for selecting a mode of the controller; and
a power conditioner coupled between the battery pack and the controller, the power conditioner configured to regulate an output voltage of the rechargeable battery pack to maintain a constant voltage provided to the heater regardless of the state of charge of the rechargeable battery pack.

2. The article of clothing of claim 1, wherein the power conditioner is configured as a step-up/step-down voltage regulator.

3. The article of clothing of claim 2, wherein the step-up/step-down regulator is configured to regulate the output voltage of the rechargeable battery pack to 12 VDC.

4. The article of clothing of claim 3, wherein the rechargeable battery pack has a voltage range of 10.8 VDC to 14.4 VDC.

5. The article of clothing of claim 2, wherein the step-up/step-down voltage regulator is a buck/boost regulator.

6. The article of clothing of claim 1, wherein the power conditioner is configured as a step-down voltage regulator.

7. The article of clothing of claim 6, wherein the rechargeable battery pack has a nominal operating voltage of 18 VDC.

8. The article of clothing of claim 1, wherein the heater has a nominal operating voltage of 12 VDC.

9. The article of clothing of claim 1, wherein the power conditioner is configured as a step-up voltage regulator.

10. The article of clothing of claim 9, wherein the rechargeable battery pack has a nominal operating voltage of 2.5 VDC.

11. The article of clothing of claim 10, wherein the power conditioner is configured to output a 12 VDC operating voltage to the heater.

12. An article of clothing comprising:
a garment body;
a heater coupled to the garment body;
a battery holder configured to receive a rechargeable battery pack;
a controller selectively providing power from the rechargeable battery pack to the heater; and
a power conditioner coupled between the battery pack and the controller, the power conditioner configured to regulate an output voltage of the rechargeable battery pack to maintain a constant voltage provided to the heater regardless of the state of charge of the rechargeable battery pack,
wherein the rechargeable battery pack has a nominal operating voltage range between 10.8 VDC and 14.4 VDC.

13. The article of clothing of claim 12, wherein the power conditioner is configured as a step-up/step-down voltage regulator.

14. The article of clothing of claim 13, wherein the step-up/step-down voltage regulator is a buck/boost regulator.

15. The article of clothing of claim 13, wherein the step-up/step-down voltage regulator is one or more of a SEPIC, Split-Pi, or Cuk voltage regulator.

16. The article of clothing of claim 12, wherein the power conditioner is configured to regulate the output voltage of the rechargeable battery pack to 12 VDC.

17. An article of clothing comprising:
a garment body;
a heater coupled to the garment body;
a battery holder configured to receive a rechargeable battery pack;
a controller selectively providing power from the rechargeable battery pack to the heater; and
a power conditioner coupled between the battery pack and the controller, the power conditioner configured to operate as a step-up/step-down voltage regulator and to regulate an output voltage of the rechargeable battery pack to maintain a constant 12 VDC voltage output to the heater regardless of the state of charge of the rechargeable battery pack,
wherein the rechargeable battery pack has a nominal operating voltage range between 2.5 VDC and 18 VDC.

18. The article of clothing of claim 17, wherein the garment is a jacket.

19. The article of clothing of claim 17, wherein the step-up/step-down voltage regulator is a buck-boost voltage regulator.

20. The article of clothing of claim 17, wherein the rechargeable battery pack is a Li-Ion power tool battery pack.
